(19) United States
(12) Patent Application Publication
(10) Pub. No.: US 2026/0360023 A1
(43) Pub. Date: Nov. 12, 2026

(54) DEMONSTRATION OF A DOMESTIC APPLIANCE

(71) Applicant: BSH Hausgeräte GmbH, München (DE)

(72) Inventors: Berkay Ogulcan TUTAL, München (DE); Baris TAPTIK, München (DE)

(21) Appl. No.: 19/130,603

(22) PCT Filed: Dec. 8, 2023
(86) PCT No.: PCT/EP2023/084836

§ 371 Date: May 16, 2025

(30) Foreign Application Priority Data
Dec. 14, 2022 (DE) 10 2022 213 646.2

(51) Int. Cl. G06T 11/00; G06V 20/20; G06V 20/60

(52) U.S. Cl. CPC G06T 11/00; G06V 20/20; G06V 20/60

(57) ABSTRACT

A method demonstrates a function of a domestic appliance. The method includes scanning an image of the domestic appliance, detecting the type of domestic appliance in the image, and determining an operating element of the domestic appliance from the image. The operating element in the image is superimposed with a virtual operating element assigned to the type. Then the superimposed image is provided to a user.

The present invention relates to the demonstration of a household appliance. In particular, the invention relates to the representation of a function of the household appliance if it cannot be put into operation.

A household appliance, for example a washing machine, a tumble dryer, a dishwasher or an oven, are often sold in large retail outlets where many different appliances are on display. In particular in cases where a household appliance requires a power, freshwater or wastewater connection, it is unusual to make the appliance available with a working connection for viewing. A potential purchaser can touch the appliance, press an operating element or where applicable open an appliance door, but no further function of the household appliance can be carried out.

Further information about the appliance is usually offered in written or pictorial form. It can however be difficult to express a unique feature of the appliance with respect to its function in static, pictorial or text form. A user can find it difficult to ascertain relevant information about the appliances and make a well-founded purchase decision.

It has been proposed to affix a graphical code to an appliance comprising a reference to a central location from which a video about the appliance's functions can be downloaded. The information conveyed thereby is however likewise static, and not every user is prepared to invest several minutes in viewing a descriptive video.

One object underlying the present invention consists in specifying an improved technique for demonstrating or operating a household appliance. The invention achieves this object by means of the subject matter of the independent claims. Subclaims represent preferred embodiments.

A method for demonstrating or operating a function of a household appliance comprises steps for scanning an image of the household appliance; identifying a type of the household appliance on the image; ascertaining an operating element of the household appliance on the image; overlaying the operating element on the image with a virtual operating element assigned to the type; and providing the overlaid image to a user.

A user can observe the household appliance directly or on the image. The virtual operating element represented there can give the user an improved impression regarding a function of the household appliance. The user can thus experience a function of the household appliance directly and straightforwardly. The user can be informed about an essential function of the household appliance in an improved manner. Both a breadth of information and a depth of information can be increased. In this way, it is possible inter alia to solve the technical problem of enabling a household appliance to be operated and experienced without even being connected to the power supply.

A region of the image disposed outside of the operating element preferably remains unchanged. The virtual operating element can be presented to the image of the household appliance in the manner of a virtual reality (VR) or an augmented reality (AR). Regions of the image on which no provision is made for the user to interact with the household appliance can be left unchanged in the image. If for example an information sign, a hand of the user or an item of additional information is disposed in such a region, these elements can be represented unchanged on the image. As a result, a more realistic impression of the household appliance can be provided during the use thereof.

It is further preferred that the image is continuously scanned, overlaid, and provided to the user. This makes it possible to transmit a more realistic impression of the household appliance. For example, it can be possible for the user to control a perspective onto the household appliance interactively. The representation can be updated several times per second, providing the user with a more realistic experience of the household appliance. In a further embodiment, the scanning and representation takes place in real time.

The virtual operating element is preferably formed by displaying the operating element of the household appliance while executing a predetermined function. On a washing machine, the predetermined function can comprise for example the execution of a predetermined washing program. On a dishwasher, the execution of a cleaning program can likewise be emulated. The virtual operating element can represent the function of the household appliance in a modified manner. In particular, sections of a function run during which no new information arises can be shortened. A function run can for example be shortened to several consecutive phases which can each have a duration of just a few seconds instead of many minutes or several hours in reality.

It is preferred that the emulated function of the household appliance continues even if the representation of the image is interrupted, for example because a perspective was selected during scanning of the image such that the operating element is not visible. In another embodiment, the function can be executed only for as long as the virtual operating element can be represented on the image. If the operating element moves outside a capture region of the camera, the emulation of the function run can be paused or aborted.

In a further embodiment, an additional operating element is represented on the image, wherein the predetermined function is controlled depending on an actuation of the additional operating element. Expressed differently, an additional operating element can be provided for controlling an emulated function or an emulated function run of the household appliance. The additional operating element can for example control the speed at which a predetermined sequence is reproduced. Such a function can also be referred to as time lapse or slow motion. In a further embodiment, it is possible to wind a represented sequence forward or backward, or to jump forward or backward in time to a position in a temporal sequence. In a further embodiment, the representation of a function run can be changed or aborted, wherein it is possible to skip a change or abort sequence which may be necessary in the actual function of the household appliance.

It is moreover preferred that the function or the function run of the household appliance can be controlled interactively. To this end, the represented virtual operating element can be configured not only for output, but also for input by a user. The actuation of a virtual operating element can influence the represented function or the function run in the same manner as an actuation of a corresponding actual operating element on a running household appliance. This enables the user to control the demonstration of the function of the household appliance interactively and to explore the handling thereof in any desired manner. It is also conceivable for a fully connected household appliance to execute the displayed behavior simultaneously alongside the emulation.

In a further embodiment, an optical code is affixed to the household appliance referencing an external resource from which the virtual operating element can be downloaded. The external resource can be in particular a central location such as a server or a cloud. The optical code can be provided for example two-dimensionally in the form of a barcode or three-dimensionally in the form of a QR code. The reference can be specified in the form of a URL. The management of the virtual operating element at the central location can enable the opening thereof to be updated in an improved manner or to be adapted to a changed functional scope of the household appliance. It is also possible to prevent a virtual operating element from being downloaded which belongs to a household appliance other than the one presently under consideration.

The optical code or a dedicated optical code can reference an external resource from which it is possible to download a program for overlaying and providing the image with the virtual operating element.

In one embodiment, the program can be configured to run on a handheld device such as a smartphone, a laptop computer or a tablet computer. In a further embodiment, a headset, smart glasses or another wearable device can be used.

In another embodiment, the external resource can deliver the program dynamically. Here, it is in particular possible to represent a web page which comprises the required program code, for example in the form of an applet. In yet another embodiment, it is also possible for the program to run on the side of the external resource and for only its output to be transmitted to the user. Such a technique is known under the designation WebAR (augmented web).

The optical code or yet a further dedicated optical code can also be used to identify a type of the household appliance. A virtual operating element assigned to the type can then be requested more easily from the external resource.

An apparatus for demonstrating a function of a household appliance comprises a camera for scanning an image of the household appliance, a display facility, and a processing facility. Here, the processing facility is configured to identify a type of the household appliance on the image; to ascertain an operating element of the household appliance on the image; to overlay the operating element on the image with a virtual operating element assigned to the type; and to provide the overlaid image to a user.

The apparatus can be formed for example on the basis of a handheld device such as a smartphone. Another wearable device or device worn on the body can likewise be used. In a further embodiment, a known smartphone or a similar handheld device can be used in a manner described herein to demonstrate a function of a household appliance.

The processing facility can be configured to partially or fully carry out a method described herein. For this purpose, the processing facility can be implemented electronically and comprise for example a programmable microcomputer or microcontroller. The method can be present in the form of a computer program product with program code means. The computer program product can also be saved on a computer-readable data carrier. Features or advantages of the method can be transferred to the apparatus, or vice versa.

A system comprises an apparatus described herein as well as a central location, which is configured to provide the virtual operating element depending on the ascertained type of a household appliance. The central location can be configured to emulate or visualize a function of the household appliance and to provide an optical output by means of the virtual operating element. In another embodiment, a program or an applet can be delivered which runs on an apparatus described herein and emulates or visualizes the function of the household appliance.

A household appliance comprises an operating element, wherein an optical code is affixed to the household appliance referencing an external resource, which is configured to provide a virtual operating element depending on an ascertained type of the household appliance. The code can comprise a reference to the type. The code is embodied preferably in optical form and further preferably in binary form. A combined code can bundle different items of information.

According to a further aspect, the invention can comprise a computer program product which can be in particular an app which can run on a mobile terminal device, which app is preferably downloaded from an app store. The computer program product comprises commands which cause a computer, in particular a mobile terminal device, to carry out the method described above when run on said computer.

Embodiments of the invention will now be described in more detail with reference to the accompanying figures, in which:

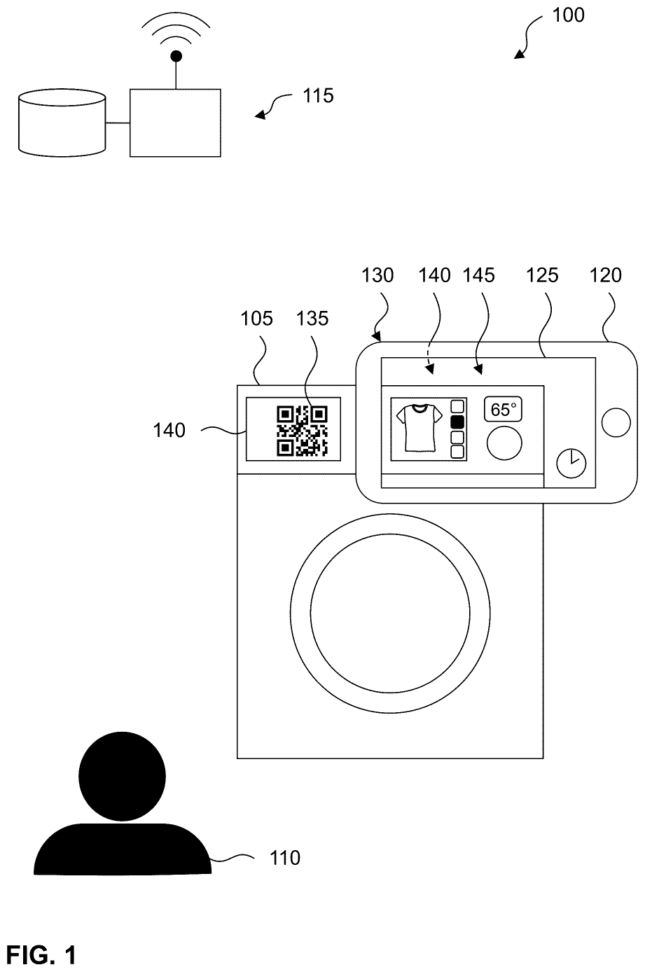

FIG. 1 represents a system with a household appliance;

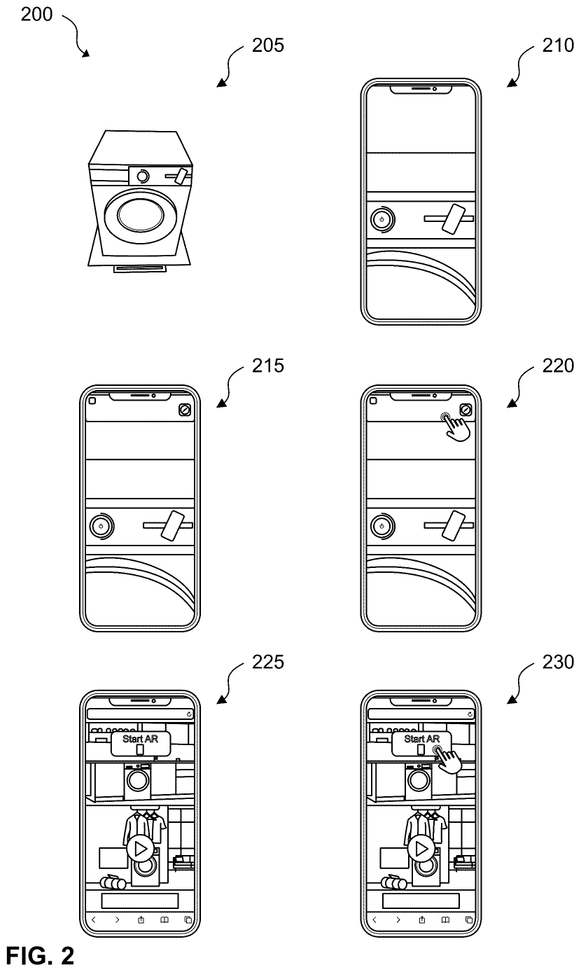

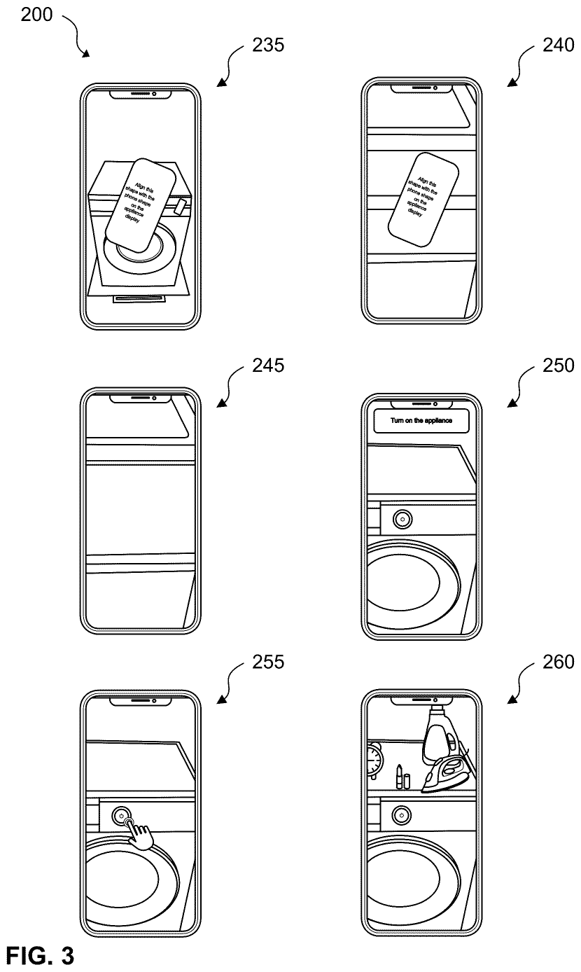

FIGS. 2 and 3 represent steps of a method for demonstrating a household appliance; and

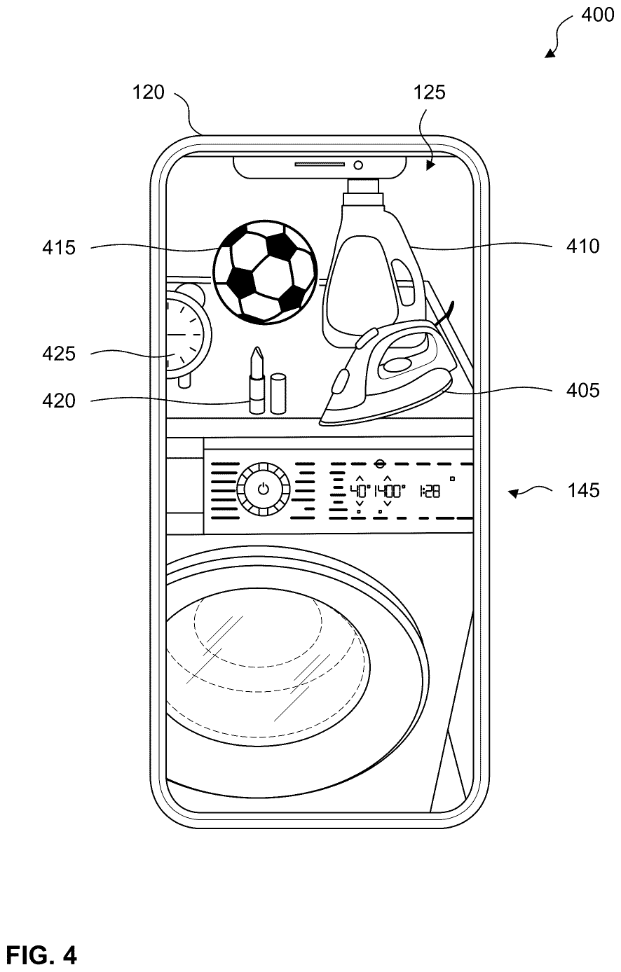

FIG. 4 represents an exemplary view of a household appliance in the manner of an augmented reality.

FIG. 1 shows a system 100 with a household appliance 105. The household appliance 105 is typically not connected ready for operation and can be arranged for example in a retail space together with other household appliances 105. Exemplary household appliances 105 comprise a dishwasher, a washing machine, and a tumble dryer. Other household appliances, in particular such which must be connected not only to a power supply network but also to a water supply or disposal network, are likewise possible. The system 100 is configured to give a potential user 110 an impression of an operation, a function, a function run or an advantage of the household appliance 105. To this end, the system 100 comprises an external resource 115, which can be embodied in particular as a server or as a service in a cloud. Furthermore, an apparatus 120 which can be handled by the user 110 is provided, which is embodied for example as a smartphone.

The apparatus 120 comprises a camera 125 and a display 130. Moreover, the apparatus 120 is configured to communicate with the external resource 115, preferably by means of a wireless network.

A code 135 can be affixed to the household appliance 105, which code is preferably optically identifiable and further preferably represented in binary form. The code 135 can comprise a reference to an address of the external resource 115. The code 135 can be captured by the camera 125 of the apparatus 120 and evaluated. The apparatus 120 can then connect to the resource 115 using the address. The code 135 can also comprise a reference to a type or a variant of the household appliance 105 presently under consideration. The reference can be part of the address or provided as a separate argument by the apparatus 120 to the external resource 115. The external resource 115 then provides the apparatus 120 with information in order to represent a virtual operating element 145 on the display 130 of the apparatus 120, which virtual operating element covers, overlays or replaces a view onto an operating element 140 of the household appliance 105.

The apparatus 120 can scan an image of the household appliance 105 by means of the camera 125, ascertain the operating element 140 on the image, overlay it with the virtual operating element 145, and provide the overlaid image on the display 130 to the user 110.

A processing of the image can take place on the side of the apparatus 120. To this end, the apparatus 120 can download a corresponding computer program from the external resource 115. The computer program can be provided in the form of an application (app) or in the form of a functionality embedded in an internet page. Moreover, the resource 115 can provide the virtual operating element 145 suited to the type of the household appliance 105. In another embodiment, an image scanned by means of the camera 125 can be transmitted to the external resource 115, processed there, transmitted back to the apparatus 120, and represented there on the display 130.

In the embodiment represented by way of example, a first operating element 140 comprises a receptacle of the household appliance 105 for detergent or care agent. Another operating element 140 can be represented dynamically on a display surface of the household appliance 105. The display surface is preferably coupled to an input surface, in particular as a touch-sensitive screen (touchscreen), and an element which is represented on the display surface and can be actuated by the user 110 can likewise be construed as an operating element 140. A further represented operating element 140 comprises a display facility which cannot be used simultaneously as an input facility, for example a temperature at which the household appliance 105 processes laundry. A yet further operating element 140 comprises an input, here in the form of a rotary knob, which cannot be used simultaneously as an output.

The virtual operating element 145 is preferably designed in its optical appearance to emulate the real or dynamic operating elements 140. The virtual operating element 145 can be actuated by the user 110 using an input element of the apparatus 120. Said input element can be formed by a touch-sensitive screen which implements the display 130.

FIGS. 2 and 3 show steps of a method 200 for demonstrating a household appliance 105. The method 200 can be carried out by means of a system 100. In a step 205, a household appliance 105 can be selected. The household appliance 105 can be for example one of a large number of household appliances 105 arranged in a retail space. In a step 210, the apparatus 120 can be used to capture the code 135 affixed to the household appliance 105. In a step 215, the code can be identified and processed in order to ascertain a reference contained therein to the external resource 115. The code can also comprise a reference to the individual household appliance 105, its type or its design. The information can be provided in the form of a URL so that it can be evaluated by an internet browser of the apparatus 120.

In a step 220, the ascertained external resource 115 can be presented to the user 110 for confirmation. If the user 110 confirms the URL, the browser of the apparatus 120 can make contact with the resource 115. The resource 115 can initially represent a welcome page, which is represented by way of example in a step 225. The welcome page can already take into consideration what type of household appliance 105 is present on the side of the user 110. Furthermore, the user 110 can be provided with advice as to how they can proceed in the proposed method 200 or what options they can apply in this regard.

In a step 230, the user 110 can effect the execution of a program which can control the demonstration of the household appliance 105 on the apparatus 120 with methods of virtual or augmented reality. It should be noted that a computer program which controls the demonstration can be executed in different embodiments on the apparatus 120 or the external resource 115. An interaction with the user 110 takes place during the demonstration or emulation by the apparatus 120.

In a step 235, represented in FIG. 3, an image is captured by means of the camera 125 of the apparatus 120 and represented on the display 130. A calibration mark can optionally be displayed in order to be able to carry out a later overlaying of a part of the captured image with an exact fit. The user 110 can be asked to align the apparatus 120 with respect to the household appliance 105 such that the represented calibration mark is congruent with a calibration mark provided on the household appliance 105. Here, the code 135 on the household appliance 105 can be used as the calibration mark. In a step 240, the user 110 can follow the prompt and calibrate the apparatus 120 with respect to the household appliance 105.

In a step 245, an operating element 140 of the household appliance 105 can be ascertained on the captured image. In a step 250, the operating element 140 on the image can be replaced or overlaid with a virtual operating element 145. The overlaid image is provided to the user 110 so that said user can perceive the household appliance 105 on the display 130 with the virtual operating element 145 instead of the actual operating element 140. The virtual operating element 145 can be operable by the user 110. In a step 255, the virtual operating element 145 can be operated, in the example represented by pressing on an activation or start button. To this end, the user 110 touches a surface of the display 130 in the region of the virtual operating element 145, and an effect of the actuation is ascertained with reference to a predetermined functional scope of the household appliance 105. Thereupon a predetermined function of the household appliance 105 can be emulated, for example a cleaning run of a washing machine. The function can also be part of an interaction concept, so that the actuation of the virtual operating element 145 can effect an output on another virtual operating element 145. In a step 260, a virtually executed function of the household appliance 105 can be represented on the display 130. To this end, an output corresponding to the emulated state of the household appliance 105 can take place by means of one or several virtual operating elements 145.

FIG. 4 shows an exemplary view 400 of a household appliance 105 in the manner of an augmented reality. An image of a household appliance 105 can be seen on the display 130 of the apparatus 120. An operating element 140 on the image is overlaid with a virtual operating element 145. In addition to possibilities described herein for the demonstration or emulation of operating and execution steps of the household appliance 105 on the overlaid image, symbols are represented by way of example which can refer to functions, advantages or options of the household appliance 105.

The household appliance 105 represented by way of example as a washing machine can have for example a washing program which makes it particularly easy to iron treated laundry. This can be represented by a first metaphor 405 in the form of an iron. Further information about the washing program can be retrieved by touching the first metaphor 405. In particular, the setting or execution of a corresponding washing program can be emulated.

A second metaphor 410 in the form of a bottle with detergent can refer for example to a dosing system in which a supply of detergent is dispensed into the washing machine 105, from which the correct quantity can be extracted and processed in each case for a large number of washing processes.

A third exemplary metaphor 415 is represented as a football and can refer to a treatment program which is particularly suitable for sports clothing.

A fourth metaphor 420 shows a cosmetics product as a reference to a washing program which is designed for the gentle removal of soiling such as lipstick from clothing.

A fifth metaphor 425 comprises by way of example a clock. The clock can symbolically display a virtual time which elapses during the emulation of a function program. In this way, a long waiting time of for example 30 minutes can be represented within a few seconds, wherein the current time expressed by means of the clock 425 changes correspondingly quickly. Optionally, the speed of the emulation can also be changed by the user 110 via the fifth metaphor 425.

### REFERENCE CHARACTERS

100 System
105 Household appliance
110 User
115 External resource
120 Apparatus
125 Camera
130 Display
135 Code
140 Operating element
145 Virtual operating element
200 Method
205 Select household appliance
210 Capture code
215 Ascertain external resource
220 Confirm external resource
225 Welcome page of the external resource
230 Start program
235 Represent calibration mark
240 Calibrate view
245 Capture operating element
250 Represent virtual operating element
255 Actuate virtual operating element
260 Display function
400 View
405 First metaphor: iron
410 Second metaphor: detergent
415 Third metaphor: football
420 Fourth metaphor: cosmetics
425 Fifth metaphor: clock

1-13. (canceled)

14. A method for demonstrating a function of a household appliance, which comprises the steps of:
scanning an image of the household appliance;
identifying a type of the household appliance in the image;
ascertaining an operating element of the household appliance in the image;
overlaying the operating element in the image with a virtual operating element assigned to the type; and
providing an overlaid image to a user.

15. The method according to claim 14, wherein a region of the image disposed outside of the operating element remains unchanged.

16. The method according to claim 14, wherein the image is continuously scanned, overlaid, and provided to the user.

17. The method according to claim 14, wherein the virtual operating element displays the operating element of the household appliance while executing a predetermined function.

18. The method according to claim 17, wherein an additional operating element is represented in the image, and the predetermined function is controlled depending on an actuation of the additional operating element.

19. The method according to claim 14, wherein:
an operation of the virtual operating element represented on the image is captured; and
an execution of a function of the household appliance assigned to the operation is emulated on the virtual operating element.

20. The method according to claim 14, wherein an optical code is affixed to the household appliance referencing an external resource from which the virtual operating element is downloaded.

21. The method according to claim 14, wherein an optical code is affixed to the household appliance referencing an external resource from which a program for overlaying and providing the image with the virtual operating element is downloaded.

22. The method according to claim 14, which further comprises identifying the type of the household appliance on a basis of an optical code affixed to the household appliance.

23. An apparatus for demonstrating a function of a household appliance, the apparatus comprising:
a camera for scanning an image of the household appliance;
a display;
a processor configured to:
identify a type of the household appliance in the image;
ascertain an operating element of the household appliance in the image;
overlay the operating element of the image with a virtual operating element assigned to the type; and
provide an overlaid image to a user.

24. A system, comprising:
said apparatus according to claim 23; and
a central location configured to provide the virtual operating element depending on an ascertained type of the household appliance.

25. A household appliance, comprising:
an operating element; and
an optical code affixed to the household appliance referencing an external resource, the external resource configured to provide a virtual operating element depending on an ascertained type of the household appliance.

26. A computer program product having computer executable instructions which when executed on a computer causes the computer to carry out the method according to claim 14.

27. The computer program product according to claim 26, wherein the computer program product is an app which is run on the computer being a mobile terminal device and is downloaded from an app store.
